(19) United States
(12) Patent Application Publication
(10) Pub. No.: US 2023/0173605 A1
(43) Pub. Date: Jun. 8, 2023

(54) INDUCTION WELDING MODULE

(71) Applicant: Wichita State University, Wichita, KS (US)

(72) Inventors: Waruna P. Seneviratne, Wichita, KS (US); John S. Tomblin, Wichita, KS (US); Brandon L. Saathoff, Wichita, KS (US); Mark T. Walthers, Wichita, KS (US); Carleton A. Hall, Wichita, KS (US); Riley Ziegler, Wichita, KS (US)

(21) Appl. No.: 18/046,530

(22) Filed: Oct. 14, 2022

Related U.S. Application Data
(60) Provisional application No. 63/255,734, filed on Oct. 14, 2021.

(51) Int. Cl. B23K 13/01

(52) U.S. Cl. CPC B23K 13/01

(57) ABSTRACT

An induction welding system employs an induction welding apparatus with an induction welding power supply and a chiller in the same enclosure. An induction welding coil is powered by the induction welding power supply. A variable force press can press together work pieces and an actuator can move the induction welding coil lengthwise along a weld joint. The weld controller repeatably conducts induction welds by controlling the induction welding power supply to power the induction welding coil and controlling the induction welding tooling to at least one of press together work pieces to be welded and move the induction welding coil lengthwise along a weld joint between work pieces to be welded.

### CROSS-REFERENCE TO RELATED APPLICATION

This application claims priority to U.S. Provisional Patent Application No. 63/255,734, filed Oct. 14, 2021, which is hereby incorporated by reference in its entirety.

### FIELD

The present disclosure generally relates to apparatuses and systems for induction welding.

### BACKGROUND

Induction welding uses an induction coil to generate a high frequency (150-400 kHz) electromagnetic field that induces eddy currents at the interface or susceptor between two work pieces. For non-ferromagnetic materials, a ferromagnetic susceptor is required to generate heat at the interface. If a susceptor is used, the susceptor stays in the weld after the work pieces are joined. In cases where carbon fiber reinforcement is used, heat can be generated without a susceptor due to the conductive nature of carbon fiber.

During welding, two work pieces are held together under pressure. The induction coil is held near the adjoined substrates to generate the heat for welding. It can be difficult to localize the heat to the interface between the two substrates because the magnetic field is strongest near the coil and therefore heats the outer surface faster than the interface (which is spaced apart from the coil by at least the thickness of one of the substrates). This limits the applications of induction welding by substrate thickness. The elevated temperatures closer to the coil can be managed by applying heat sinks to the surface or configuring the substrates for less inductive heating away from the interface (e.g., by changing fiber orientation along the thickness of the substrate).

Various factors affect induction welding processes. For example, in a carbon fiber substrate, the substrate fiber form and layup orientations play a significant role in the induction heating process. Several electrical interactions take place to generate heat in the carbon fiber substrate. The electrical properties associated with the laminate are very challenging to measure experimentally. Heat is generated by fiber heating (R_{f}), dielectric heating (R_{d}), and fiber-to-fiber contact (R_{c}). The contact resistance becomes the dominant form of heating when the fibers are in direct contact at angles with respect to one another such as in a weave. Hence, weaves such as a 5-harness, will heat more efficiently than a unidirectional composite. Heating efficiency is important in the design of the induction welding process. The induction coil design also has an effect on the induction welding process. An efficient coil design uniformly heats the joint interface to the appropriate processing temperature while minimizing the applied current.

### SUMMARY

In one aspect, an induction welding apparatus comprises an apparatus enclosure. An induction welding power supply is received in the apparatus enclosure. A chiller is received in the apparatus enclosure and fluidly connected to the induction welding power supply. An induction welding coil is operatively connected to the induction welding power supply. A cable operatively connects the induction welding coil to the induction welding power supply such that the induction welding coil is movable in relation to the apparatus enclosure. An HMI device is configured to receive user input selecting a weld control routine. A weld controller is configured to control the induction welding apparatus to make an induction weld based on a user input selecting a weld control routine

In another aspect, an induction welding apparatus for welding work pieces together at a weld joint comprises an apparatus enclosure. An induction welding power supply is received in the apparatus enclosure. An induction welding coil is configured to be powered by the induction welding power supply. A plurality of temperature sensor connectors is on the apparatus enclosure. Each temperature sensor connector is configured to connect to a sacrificial temperature sensor that may be placed at a joint between work pieces while the work pieces are being welded together to output a temperature signal representative of temperature of the joint during welding. A weld controller is connected to the plurality of temperature sensor connectors and configured to control the induction welding power supply to execute a weld control routine based on one or more temperature signals from one or more sacrificial temperature sensors connected to the temperature sensor connectors.

In another aspect, an induction welding apparatus for welding work pieces together at a weld joint comprises an induction welding power supply. An induction welding coil is configured to be powered by the induction welding power supply. A weld controller is configured to control the induction welding power supply to power the induction welding coil to repeatably execute weld routines. The weld controller is configured to connect to one or more sacrificial temperature sensors that may be disposed at the joint while the work pieces are being welded together to output a temperature signal representative of temperature of the joint during welding. A feedback circuit provides information about the power output from the induction welding power supply during execution of weld routine. The weld controller is configured to selectively control weld routines based on feedback from either of (1) one or more sacrificial temperature sensors and (2) the feedback circuit.

In another aspect, an induction welding system comprises an induction welding apparatus comprising an induction welding power supply. An induction welding coil is configured to be powered by the induction welding power supply. A weld controller is configured to control the induction welding power supply to power the induction welding coil to repeatably execute weld routines. Induction welding tooling comprises at least one of (i) a variable force press configured to press together work pieces to be welded and (ii) an actuator for moving the induction welding coil lengthwise along a weld joint between work pieces to be welded. The weld controller is configured to repeatably conduct induction welds by controlling the induction welding power supply to power the induction welding coil and controlling the induction welding tooling to at least one of press together work pieces to be welded and move the induction welding coil lengthwise along a weld joint between work pieces to be welded.

In another aspect, a method of developing an induction welding process comprises using a weld controller to control an induction welding power supply of an induction welding apparatus to power an induction welding coil to inductively heat a joint between work pieces to a predefined set point temperature based on feedback from one or more sacrificial temperature sensors connected to one or more temperature sensor connectors integrated into the induction welding apparatus. Information about the power output to the induction welding coil during the preceding step is stored.

Other aspects and features will be apparent hereinafter.

### BRIEF DESCRIPTION OF THE DRAWINGS

FIG. 1 is a schematic illustration of an induction welding system according to the present disclosure in a configuration employing static process tooling;

FIG. 2 is a schematic illustration of the induction welding system employing continuous process tooling;

FIG. 3 is an elevation of one side of an induction welding apparatus of the induction welding system;

FIG. 4 is an elevation of another side of the induction welding apparatus;

FIG. 5 is an elevation of another side of the indication welding apparatus with exterior panels removed to reveal internal components; and

FIGS. 6A and 6B are a schematic block diagram of control architecture for the induction welding apparatus, induction welding tooling, and control station.

Corresponding reference numbers indicate corresponding parts throughout the drawings.

### DETAILED DESCRIPTION

The inventors have recognized that, in view of the above-discussed complexities and other poorly defined and unknown variables affecting how substrates join together by induction welding, it is difficult to accurately predict how induction welding processes will perform. Hence, it is important to empirically validate induction welding parameters before implementing induction welding in production. For example, in aerospace applications, it is critical to validate that the defined parameters for an induction welding process yield weld joints with the necessary characteristics for the application. Furthermore, it is important to ensure that, during production, welds are carried out in accordance with the empirically validated process parameter. The inventors believe that it is possible to improve existing induction welding products to provide easier and more accurate validation of induction welding parameters, as well as easier and more accurate verification of compliance with the validated parameters. Further, the inventors believe that it is possible to provide an integrated induction welding system that is more user-friendly and requires less on-site integration of disparate parts than currently available induction welding products.

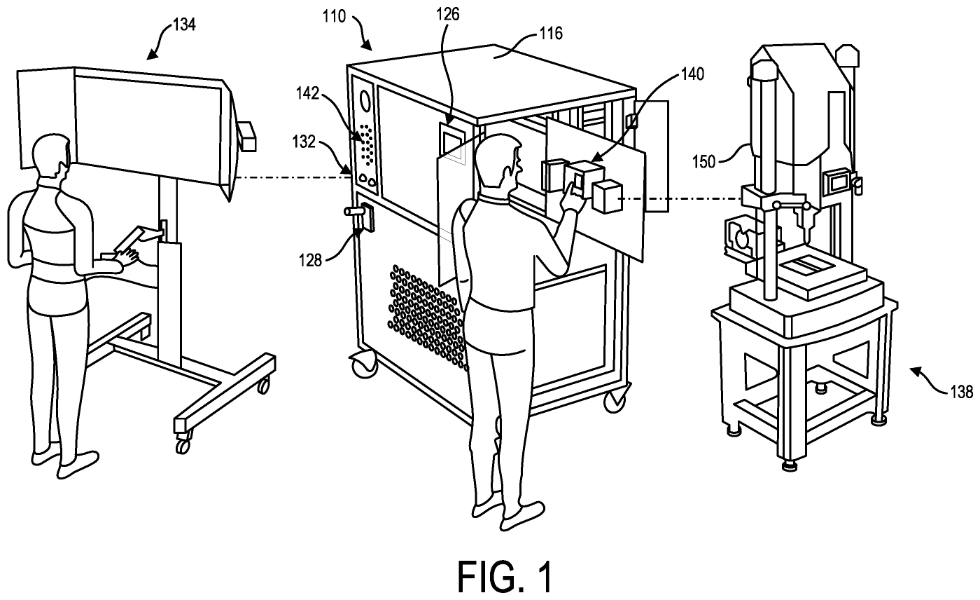

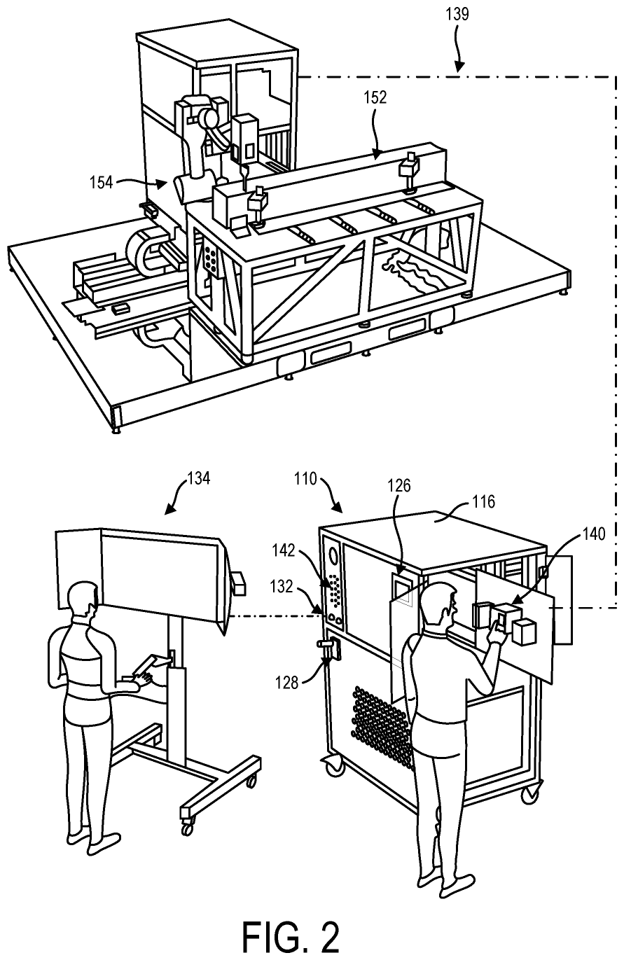

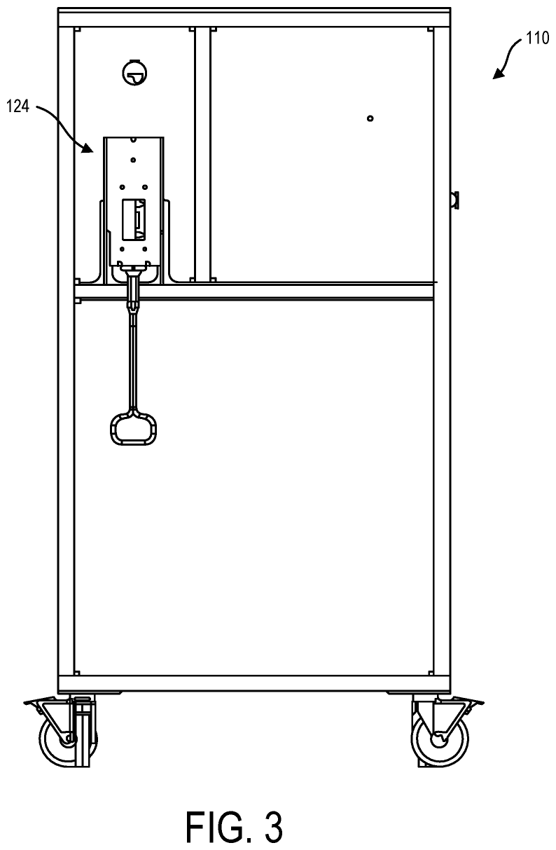

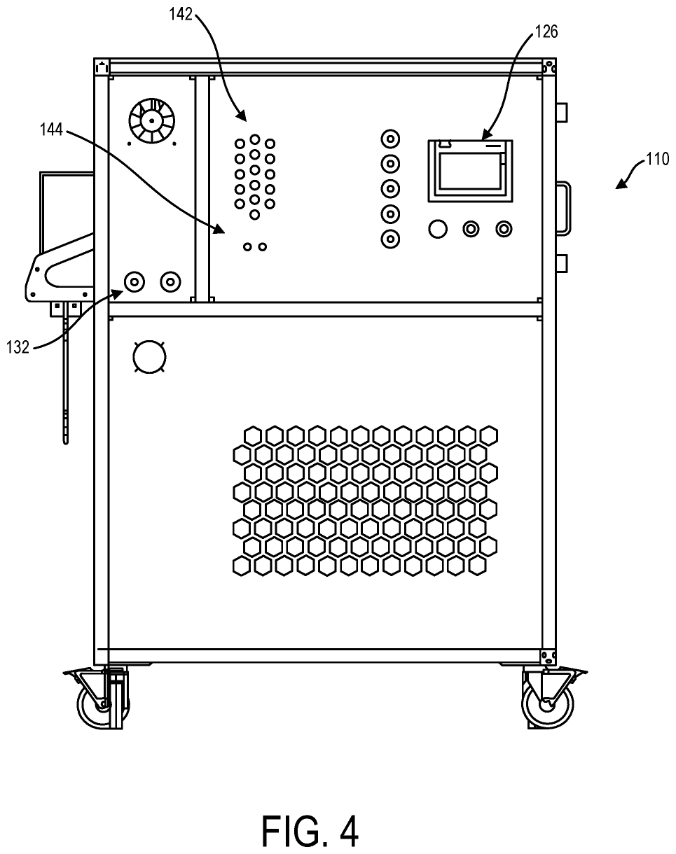

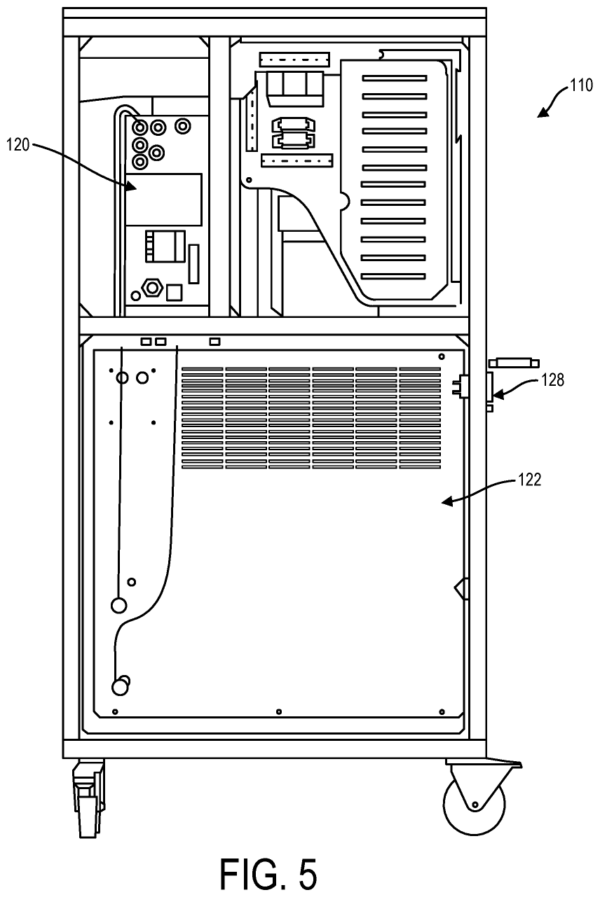

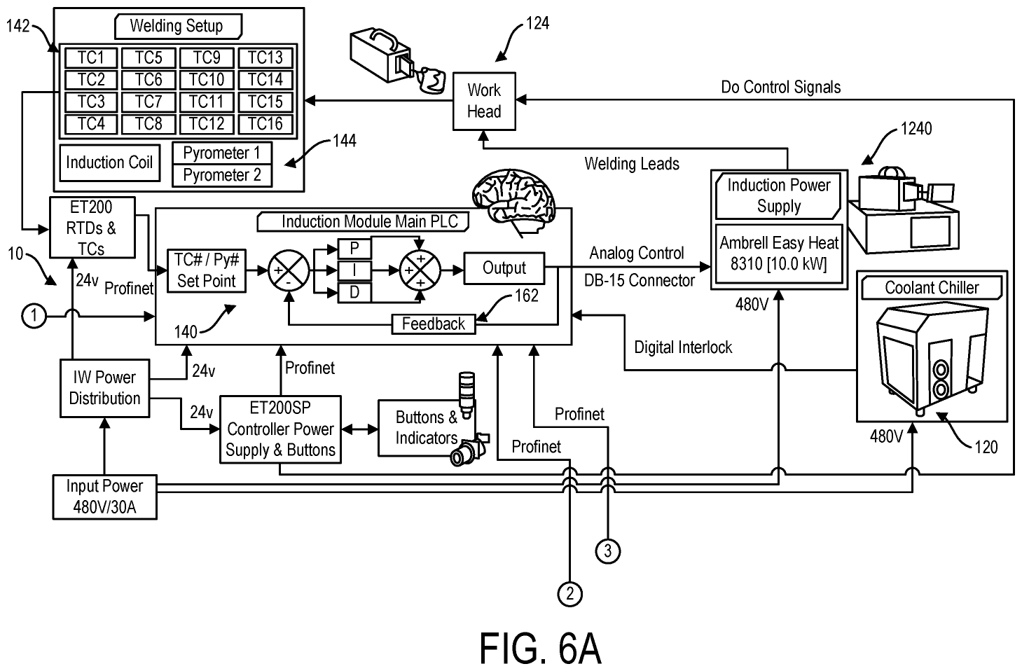

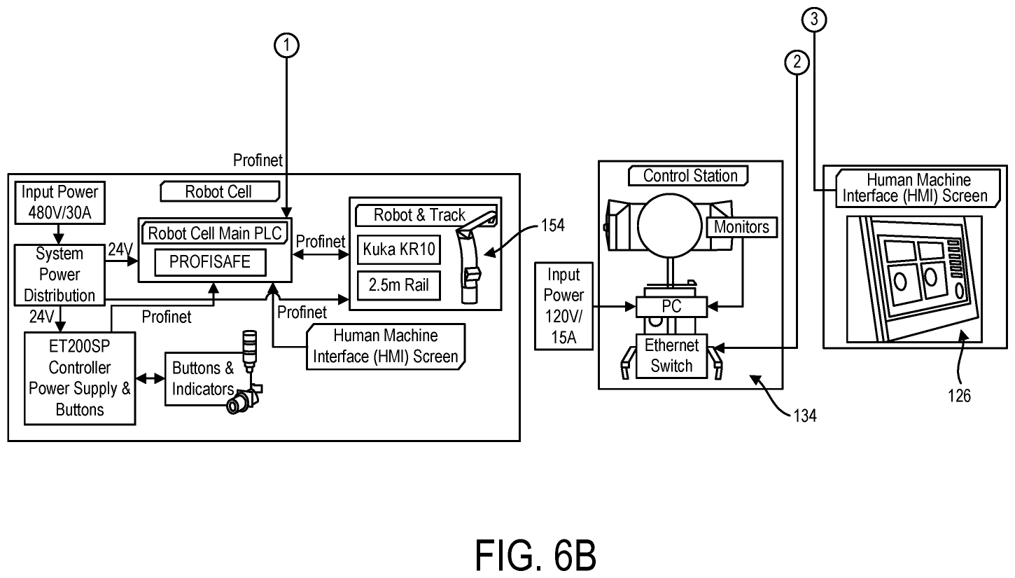

Referring to FIGS. 1-6, an exemplary embodiment of an induction welding system is generally indicated at reference numeral 10. The induction welding system 10 is broadly configured to join together two separate work pieces (broadly, substrates) by generating an electromagnetic field that induces eddy currents in electrically conductive material to generate heat that fuses the work pieces together at a weld joint. It will be understood that the illustrated induction welding system 10 can be used to join together work pieces with or without a susceptor between the work pieces.

The illustrated induction welding system generally comprises an induction welding apparatus 110, a remote control station 134, and induction welding tooling 138, 139. As will be explained in further detail below, the induction welding apparatus 110 is configured to automatically control induction welding operations based on predefined weld control routines. Moreover, the induction welding apparatus 110 is configured to connect to the induction welding tooling 138, 139 to control the induction welding tooling during induction welding operations. As will be further explained below, the control station 134 is broadly configured to enable a user to define weld control routines for execution by the welding apparatus. Furthermore, the control station 134 is connected to the induction welding apparatus 110 to receive information about the welding operations being performed, which enables a user of the system 10 to conduct process development and/or process validation.

The induction welding apparatus 110 includes an apparatus enclosure 116 that, in the illustrated embodiment, holds the componentry of the apparatus on a single contiguous footprint. The apparatus enclosure 116 suitably comprises a set of walls held together by a frame. In the illustrated embodiment, the enclosure 116 receives an induction welding power supply 120, a chiller 122, and fluid passaging operatively connecting the chiller to the induction welding power supply. Various induction welding power supplies can be used without departing from the scope of the disclosure, but in the illustrated embodiment, the induction welding power supply 120 is an Ambrell EASYHEAT 8310LI solid-state induction power supply capable of delivering 8.3 kW of power. The illustrated chiller 122 is a Dimplex Koolant Kooler, although other types of chillers can also be used without departing from the scope of the disclosure. One side of the enclosure 116 includes a dock for an induction welding work head 124. The work head 124 includes an induction coil. The work head 124 is connected to the power supply 120 by a multi-function cable that communicates power and chilling fluid to the coil. The cable allows the work head 124 to move from the dock to the tooling 138, 139 during an induction welding process. During use, the power supply 120 powers the coil 124 with alternating current to generate an electromagnetic field configured for induction welding. In addition, the chiller 122 recirculates chilling fluid through the induction coil to prevent the coil from overheating.

The induction welding apparatus 110 further includes a human machine interface (HMI) 126 and a weld controller 140 supported on the apparatus enclosure 116. In the illustrated embodiment, the HMI 126 is a touchscreen display that allows a user to select a weld control routine. For example, the user can select a weld control routine based on one or more predefined set point temperatures or select a weld control routine based on one or more predefined power outputs (e.g., alternating current parameters), and the weld controller 140 will automatically conduct a welding operation in accordance with the selection. Thus, the HMI 126 is operatively connected to the weld controller 140, and the weld controller is operatively connected to the power supply 120 and chiller 122. For example, in one or more embodiments, the power supply 120 communicates with the controller 140 via RS485 connections. In the illustrated embodiment, all of the components of the induction welding apparatus 110 are operatively connected to main power by a single power input 128 (e.g., a 480V power input).

In the illustrated embodiment, the weld controller 140 comprises a closed loop (e.g., PID) controller that controls the weld routine based on feedback from the welding process. That is, the weld controller 140 is configured to output a control signal to the power supply 120 that varies the output of the power supply based on feedback from the process as it is being conducted. As explained more fully below, in certain implementations, the weld controller 140 can control the weld routine based on temperature feedback. In addition, the illustrated induction welding apparatus 110 includes an integrated feedback circuit 162 that detects the output signal from the controller to the power supply 120 and inputs this information to the weld controller 140. In certain implementations, the weld controller 140 uses this power output feedback signal to adjust its control signal output to the power supply 120 to accord with the predefined power output of a weld routine.

The induction welding apparatus 110 further includes a plurality of sacrificial temperature sensor connectors 142 configured to connect to sacrificial temperature sensors, such as thermocouples. Each of the sacrificial temperature sensors can be placed at or near the interface of the work pieces being welded. During a weld, the sacrificial temperature sensors output a temperature signal representative of the temperature of the weld interface. The sacrificial temperature sensor connectors 142 pass temperature signals from the sacrificial temperature sensors to the controller 140. In certain implementations, the weld controller 140 controls the power supply 120 to execute weld control routines based on one or more temperature signals from one or more sacrificial temperature sensors. For example, in one or more embodiments, a weld control routine includes one or more temperature set points, and the weld controller 140 executes the weld by using PID control logic based on feedback from the temperature sensors to adjust the control signal output to the power supply 120 to achieve the set point temperature at the weld joint.

The illustrated induction welding apparatus 110 further comprises a plurality of reusable temperature sensor connectors 144 configured to connect to reusable temperature sensors, such as optical pyrometers. During a weld, the reusable temperature sensors are configured to output a temperature signal representative of the temperature of the weld interface. But unlike the sacrificial temperature sensors discussed above, the reusable temperature sensors can operate at positions spaced apart from the weld joint so that they are not destroyed or integrated into the weld joint during the induction welding process. The reusable temperature sensor connectors 144 pass temperature signals from the reusable temperature sensors to the controller 140. In certain implementations, the weld controller 140 controls the power supply 120 to execute weld control routines based on one or more temperature signals from one or more reusable temperature sensors. For example, in one or more embodiments, a weld control routine includes one or more temperature set points, and the weld controller 140 executes the weld by using PID control logic based on feedback from the reusable temperature sensors to adjust the control signal output to the power supply 120 to achieve the set point temperature at the weld joint.

The apparatus enclosure 110 also includes a pair of data ports 132 (e.g., Ethernet ports). The data ports 132 are configured to connect the induction welding apparatus 110 to the remote control station 134 and the induction welding tooling 138, 139, thereby integrating the system 10 so that the induction welding apparatus, the control station, and the induction welding tooling are coordinated. In the illustrated embodiment, the apparatus enclosure 110, the remote control station 134, and the welding tooling 138, 139 communicate via Profinet communications, though other control protocols may also be used without departing from the scope of the disclosure.

The induction welding tooling 138, 139 is generally configured to press the work pieces 104, 106 together during a welding operation, and optionally, to control movement of the induction welding head work along a weld joint. In the illustrated embodiment, the welding system 10 includes both static process tooling 138 and continuous process tooling 139. The static process tooling 138 includes a variable force press 150 configured to be selectively actuated by the control processor 140 to impart the desired amount of pressing force on two relatively small work pieces to provide a small-scale simulation of what could be a much larger production weld. The variable force press 150 enables quick and/or incremental adjustments to the pressing force to facilitate process development. In certain embodiments, the static process tooling 138 can comprise a fixture for holding the work head 124 at one or more defined distances from each weld joint during process development welding. For example, the fixture can allow for adjustment of the work head 124 to a plurality of spaced apart distances from the work pieces so that different weld conditions can be considered in process development.

In the illustrated embodiment, the continuous process tooling 139 comprises a fixable pressing jig 152 for pressing large work pieces together at a defined pressing force in accordance with validated weld process parameters. In one or embodiments, the pressing force of the jig 152 is adjustable to facilitate process development. The continuous process tooling 139 further comprises a track- or gantry-mounted robot 154 (e.g., a Kuka KR10 on a 2.5-m rail) configured to move the work head 124 along the length of the weld joint in accordance with a defined weld control routine, e.g., at a defined distance from the work pieces and/or a defined speed. Again, these parameters of the weld control routine can suitably be adjusted to facilitate process development.

In the illustrated induction welding system 10, the control station 134 connects to the controller 140 via one of the Ethernet ports 132. The control station 134 includes a computer (e.g., a processor and memory storing processor-executable instructions that are executed) for running weld control software. In certain embodiments, the weld control software enables a user to program a weld control routine. In one embodiment, the weld control software enables the user to define a weld control routine that can be executed by the weld controller 140. In the illustrated embodiment, the weld control software is configured to define the weld routine in terms of either temperature parameters or power parameters and store the newly defined weld routine in memory accessible to the controller 140. Suitably, the user can name the weld routine, select the time, temperature, and power parameters for the weld routine, and define tooling parameters such as coil movement speed, joint pressure, etc.

During an induction welding operation, the controller 140 is configured to reference a stored weld routine defined by the weld control software and execute the predefined weld. In one or more embodiments, weld routines programmed by the control station 134 using the weld control software are stored in memory that can be accessed by the HMI device 126 on the induction welding apparatus 110. Thus, after defining a weld routine using the control station 134, the user can then select that weld routine from the HMI 126. To enable the controller 140 to execute a weld based on a weld control routine created in the weld control software, the weld control software may utilize a standard communication protocol such as Siemens Open Platform Communication (OPC). Those skilled in the art will appreciate that OPC can allow the weld control software to read and write communication “tags” to the memory of the weld controller 140. The tags are data types stored in memory of the weld controller 140 that control data manipulation and hardware processors. A tag is created as a placeholder in memory inside the weld control software. The controller can read the static IP address of the tag located in the weld controller memory. The tag name and data type, such as float, integer, or Boolean, must be known to read and write data from the tag.

In certain embodiments, the weld controller 140 is configured to store real time data from a welding operation into memory that can be accessed by the weld control software for later visualization, verification, and/or analysis. Thus, the controller memory may be used to store feedback from the induction welding tool 138, the temperature sensors, the power feedback circuit 162, etc. During each weld, information about the temperature of the weld joint over time and/or the power output from the power supply 120 over time is stored in the memory. The weld control software is configured to access the data obtained by the controller 140 and store it in an external database. In one or more embodiments, the database is accessed through an SQLite database management system. The weld control software is configured to display the process data in a table, charts, or any other appropriate form. The illustrated weld control software can also automatically generate key performance metrics and display them.

A method of using the induction welding system 10 will now be briefly described. In general, the induction welding system 10 enables two modes of operation: a process development mode and a production process mode. The process development mode broadly enables the user to determine the power characteristics needed to produce a desired weld. In the production process mode, the welding system 10 is used to perform welds for production purposes (e.g., the joining of composite parts to be used in an aircraft or other goods).

In the process development mode, the weld control software is used to program a desired weld based on defined temperature parameters. The user positions the desired sample work pieces in either tooling 138, 139. The user connects the desired number of sacrificial temperature sensors to the connectors 108 and positions them at the weld joint. In certain embodiments. After the work pieces of the weld are in position, the user may select the weld control routine of interest from the HMI. Upon instructions from the HMI, the weld controller 140 automatically executes a welding operation based on the temperature-versus-time parameters defined in the weld control routine. The controller 140 receives feedback from the sacrificial temperature sensors and uses PID control to adjust power output to the coil head 124 as needed to achieve the desired set point temperature(s) at the joint. When the continuous process tooling 139 is used, the controller 140 also controls the robot 154 to move the coil along the weld in such a way as to meet the temperature requirements of the weld control routine. Throughout the weld operation, information from the process is being stored to local controller memory. For example, the controller stores information about the power (alternating current) output to the coil head 124 over time, information about the temperatures detected by the sacrificial temperature sensors over time, information about the amount of pressure being applied by the press, and information about the movement of the coil by the robot 154, if applicable. This information may broadly be called “weld process data”.

The weld control software reads the weld process data from the local weld controller memory and writes it into an external database. After the weld is complete, the user can physically inspect the weld (e.g., by hand or using any suitable destructive or non-destructive testing procedures) to determine if the weld meets expectations. Additionally, the user can use the weld control software to assess whether the weld process data indicates that the weld was acceptable. For example, the user can assess whether the welding system 10 was able to consistently achieve the desired welding temperatures throughout the weld process. If the weld is unacceptable, the user can make adjustment to the weld control routine and test a new set of work pieces using the adjusted weld control routine. This process is repeated as many times as required to produce an acceptable weld.

If the weld is acceptable, the user can evaluate the weld process data and define a new weld control routine based on the weld process data in terms of defined power parameters. For example, the user defines a set of power set points that correspond with the weld process data for the successfully executed weld conducted in the process development mode. Because the weld process data for a successful process development weld includes temperature data, the user can have confidence that the power parameters for a new production weld control routine will yield a weld with the desired temperature characteristics. Thus, the process development mode can yield weld control routines programmed in terms of power-versus-time that are validated to achieve certain temperature specifications.

In the production process mode, the user can use the validated weld control routine to repeatably conduct welding operations that conform to the desired weld specifications. For each weld, the user positions the production work pieces in the tooling so that they are ready to weld. No sacrificial temperature sensors are required in the production process mode because the production welds are conducted based on routines defined in terms of power parameters. Reusable temperature sensors may also be used during production processes to provide verification that process temperatures are being reached. Upon instructions from the HMI, the weld controller 140 automatically executes a welding operation based on the power parameters defined in the weld control routine. The controller outputs a control signal to the power supply 120 that causes the power supply to power the induction welding coil 124 in accordance with the weld control routine. In addition, for a continuous weld made using the continuous process tooling, the controller 140 outputs a signal to the robot 154 that causes the robot to move the coil 124 as required by the weld control routine. The controller 140 simultaneously receives feedback from the feedback circuit 162 and uses closed loop control to adjust the control signal to the power supply 120 as needed to achieve the power parameters defined in the weld control routine. Throughout the weld operation, information from the process is stored to local controller memory. For example, the controller stores information about the power output to the induction welding coil 124 over time and optionally temperature signal information from the reusable temperature sensors. In certain embodiments, the continuous process tooling 139 includes one or more load cells or pressure sensors that detect the force with which the jig presses the work pieces together, and these sensing devices output representative measurement signals to the controller 140 so that the controller likewise stores this process data into memory. The surface temperature of the surrounding tooling and material is also monitored (e.g., using reusable temperature sensors or additional sacrificial temperature sensors). The system can then use these other temperature signals away from the interface of the joint to either monitor or control (CLC) production processes. The weld control software reads the weld process data from the local weld controller memory and writes it into an external database. After the weld is complete, the weld process data stored in the database serves as a record to validate that the weld was performed according to specification.

When introducing elements of aspects of the invention or the embodiments thereof, the articles “a,” “an,” “the,” and “said” are intended to mean that there are one or more of the elements. The terms “comprising,” “including,” and “having” are intended to be inclusive and mean that there may be additional elements other than the listed elements.

Not all of the depicted components illustrated or described may be required. In addition, some implementations and embodiments may include additional components. Variations in the arrangement and type of the components may be made without departing from the spirit or scope of the claims as set forth herein. Additional, different or fewer components may be provided and components may be combined. Alternatively, or in addition, a component may be implemented by several components.

The above description illustrates the aspects of the invention by way of example and not by way of limitation. This description enables one skilled in the art to make and use the aspects of the invention, and describes several embodiments, adaptations, variations, alternatives and uses of the aspects of the invention, including what is presently believed to be the best mode of carrying out the aspects of the invention. Additionally, it is to be understood that the aspects of the invention are not limited in its application to the details of construction and the arrangement of components set forth in the following description or illustrated in the drawings. The aspects of the invention are capable of other embodiments and of being practiced or carried out in various ways. Also, it will be understood that the phraseology and terminology used herein is for the purpose of description and should not be regarded as limiting.

This disclosure also contemplates iterative scenarios for developing a continuous induction welding process. For example, in a first process development step, the static process tooling 138 can be used to gain an understanding of temperature and pressure requirements. And then in a second process development, these temperature and pressure parameters can be used as a starting point for developing a weld control routine for a continuous welding process using the continuous process tooling 139. Still other variations of the above described welding methods are possible without departing from the scope of the disclosure.

It will be apparent that modifications and variations are possible without departing from the scope of the invention defined in the appended claims. As various changes could be made in the above constructions and methods without departing from the scope of the invention, it is intended that all matter contained in the above description and shown in the accompanying drawings shall be interpreted as illustrative and not in a limiting sense.

In view of the above, it will be seen that several advantages of the aspects of the invention are achieved and other advantageous results attained.

The Abstract and Summary are provided to help the reader quickly ascertain the nature of the technical disclosure. They are submitted with the understanding that they will not be used to interpret or limit the scope or meaning of the claims. The Summary is provided to introduce a selection of concepts in simplified form that are further described in the Detailed Description. The Summary is not intended to identify key features or essential features of the claimed subject matter, nor is it intended to be used as an aid in determining the claimed subject matter.

What is claimed is:

1. An induction welding apparatus comprising:
an apparatus enclosure;
an induction welding power supply received in the apparatus enclosure;
a chiller received in the apparatus enclosure and fluidly connected to the induction welding power supply;
an induction welding coil operatively connected to the induction welding power supply;
a cable operatively connecting the induction welding coil to the induction welding power supply such that the induction welding coil is movable in relation to the apparatus enclosure;
an HMI device configured to receive user input selecting a weld control routine; and
a weld controller configured to control the induction welding apparatus to make an induction weld based on a user input selecting a weld control routine.

2. The induction welding apparatus as set forth in claim 1, wherein the HMI device is mounted on the apparatus enclosure

3. The induction welding apparatus as set forth in claim 1, wherein the weld controller is received in the apparatus enclosure.

4. The induction welding apparatus as set forth in claim 1, further comprising a single power input configured to connect the induction welding power supply, the chiller, the HMI device, and the weld controller to main power.

5. The induction welding apparatus as set forth in claim 1, wherein the weld controller is configured to control weld tooling.

6. The induction welding apparatus as set forth in claim 5, wherein the weld controller is configured to control a variable force press of the weld tooling to press first and second work pieces toward one another at a force defined in a weld control routine selected by user input to the HMI device.

7. The induction welding apparatus as set forth in claim 5, wherein the weld controller is configured to control a robot of the weld tooling to move the induction welding coil lengthwise along a weld joint.

8. The induction welding apparatus as set forth in claim 7, wherein the weld controller is configured to control the robot the move the induction welding coil lengthwise along the weld joint at a speed defined in a weld control routine selected by a user input to the HMI device.

9. The induction welding apparatus as set forth in claim 7, wherein the weld controller is configured to control the robot to move the induction welding coil lengthwise along the weld joint at a distance from the weld joint defined in a weld control routine selected by a user input to the HMI device.

10. The induction welding apparatus as set forth in claim 1, further comprising a dock on the enclosure on which the induction welding coil is dockable.

11. The induction welding apparatus as set forth in claim 1, further comprising a plurality of sacrificial temperature sensor connectors configured to connect individual sacrificial temperature sensors to the weld controller such that the sacrificial temperature sensor connectors pass temperature signals from the sacrificial temperature sensors to the weld controller.

12. The induction welding apparatus as set forth in claim 11, wherein the weld controller is configured to execute PID control based on the temperature signals to adjust the power supplied from the induction welding power supply to the induction welding coil to achieve a predefined set point temperature defined by a weld control routine selected by a user input to the HMI device.

13. The induction welding apparatus as set forth in claim 1, further comprising one or more reusable temperature sensor connectors configured to connect one or more reusable temperature sensors to the weld controller such that the reusable temperature sensor connectors pass temperature signals from the reusable temperature sensors to the weld controller.

14. The induction welding apparatus as set forth in claim 13, wherein the weld controller is configured to execute PID control based on the temperature signals to adjust the power supplied from the induction welding power supply to the induction welding coil to achieve a predefined set point temperature defined by a weld control routine selected by a user input to the HMI device.

15. The induction welding apparatus as set forth in claim 1, further comprising a memory configured to store information about power outputted by the induction welding apparatus during each induction weld made by the induction welding apparatus.

16. The induction welding apparatus as set forth in claim 15, wherein the weld controller is configured to selectively control the induction welding apparatus to make an induction weld based on the stored information to output power from the induction welding apparatus in accordance with the power outputted by the induction welding apparatus during a previous induction weld.

17. An induction welding apparatus for welding work pieces together at a weld joint, the induction welding apparatus comprising:
an apparatus enclosure;
an induction welding power supply received in the apparatus enclosure;
an induction welding coil configured to be powered by the induction welding power supply;
a plurality of temperature sensor connectors on the apparatus enclosure, each temperature sensor connector being configured to connect to a sacrificial temperature sensor that may be placed at a joint between work pieces while the work pieces are being welded together to output a temperature signal representative of temperature of the joint during welding; and
a weld controller connected to the plurality of temperature sensor connectors and configured to control the induction welding power supply to execute a weld control routine based on one or more temperature signals from one or more sacrificial temperature sensors connected to the temperature sensor connectors.

18. An induction welding apparatus for welding work pieces together at a weld joint, the induction welding apparatus comprising:
an induction welding power supply;
an induction welding coil configured to be powered by the induction welding power supply;
a weld controller configured to control the induction welding power supply to power the induction welding coil to repeatably execute weld routines, wherein the weld controller is configured to connect to one or more sacrificial temperature sensors that may be disposed at the joint while the work pieces are being welded together to output a temperature signal representative of temperature of the joint during welding; and
a feedback circuit providing information about the power output from the induction welding power supply during execution of weld routine;
wherein the weld controller is configured to selectively control weld routines based on feedback from either of (1) one or more sacrificial temperature sensors and (2) the feedback circuit.

19. The induction welding apparatus as set forth in claim 18 further comprising a memory configured to store the feedback during each weld routine.

20. An induction welding system comprising:
an induction welding apparatus comprising:
an induction welding power supply;
an induction welding coil configured to be powered by the induction welding power supply; and
a weld controller configured to control the induction welding power supply to power the induction welding coil to repeatably execute weld routines; and
induction welding tooling comprising at least one of (i) a variable force press configured to press together work pieces to be welded and (ii) an actuator for moving the induction welding coil lengthwise along a weld joint between work pieces to be welded;
wherein the weld controller is configured to repeatably conduct induction welds by controlling the induction welding power supply to power the induction welding coil and controlling the induction welding tooling to at least one of press together work pieces to be welded and move the induction welding coil lengthwise along a weld joint between work pieces to be welded.

21. A method of developing an induction welding process, the method comprising:
using a weld controller to control an induction welding power supply of an induction welding apparatus to power an induction welding coil to inductively heat a joint between work pieces to a predefined set point temperature based on feedback from one or more sacrificial temperature sensors connected to one or more temperature sensor connectors integrated into the induction welding apparatus; and
storing information about the power output to the induction welding coil during the preceding step.

22. A method of performing a repeatable welding process, the method comprising repeatably controlling an induction welding power supply of an induction welding apparatus to output power to the induction welding coil based on the stored information about the power output to the induction welding coil from the method of developing an induction welding process set forth in claim 21.
